(19) United States
(12) Patent Application Publication
(10) Pub. No.: US 2002/0036799 A1
(43) Pub. Date: Mar. 28, 2002

(54) Image processing apparatus and image forming system

(76) Inventors: Hiroshi Sumiyama, Aichi-Ken (JP); Hironobu Nakata, Itami-shi (JP); Takeshi Morikawa, Itami-shi (JP); Munetaka Fujita, Toyokawa-Shi (JP); Tatsuji Hirakawa, Aichi-Ken (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 09/960,528

(22) Filed: Sep. 24, 2001

(30) Foreign Application Priority Data
Sep. 26, 2000 (JP) 2000-292740

(51) Int. Cl. G06K 15/02; G06F 3/12; G06F 13/00

(52) U.S. Cl. 358/1.15

(57) ABSTRACT

In An image forming system having a plurality of printers and an image processing apparatus connected each other through a network, a printer to be sent a print job from the image processing apparatus is selected based on a degree of matching of a comparison between kinds of image size in the job and kinds of paper size installed in each printer.

### RELATED APPLICATION

This application is based on application No. 2000-292740 filed in Japan, the entire content of which is hereby incorporated by reference.

### BACKGROUND OF THE INVENTION

1. Field of the Invention

The present invention relates to an invention that is applied to an image processing apparatus to be connected with a plurality of printers through a network.

2. Description of the Related Art

Systems in which multiple printers are connected over a network and in which a print job is sent from a personal computer that is also connected over the network to a selected printer for printing have been used in offices in recent years.

Normally, each printer holds paper of various different sizes, but does not always hold paper of all of the sizes instructed by the computer. Therefore, where a print job including a multiple paper size requirement is output to a printer, unless that printer holds all paper sizes required by the print job, it cannot perform all of the instructed print job and the printing operation stops midway through. Various proposals have been made in order to resolve this problem.

For example, Japanese Laid-Open Patent Application Hei 10-105353 discloses a device equipped with a means that specifies a destination printer for each paper size, such that one job is distributed to several printers. Japanese Laid-Open Patent Application Hei 10-198540 discloses a device that is equipped with a means to control information including the capabilities, status and locations of installation regarding multiple printers, and that divides a print job in accordance with the nature of the print job and the job division policy, and allocates each portion of the job to a prescribed printer. Japanese Laid-Open Patent Application Hei 11-314438 discloses a device that, if a job stops midway through due to an error, transfers the remaining pages to a different printer.

When a print job including a multiple paper size requirement is received by any of the printers disclosed in each laid-open patent application, and if complete printing is not possible through that printer only, a portion of the job is separated and output to a different printer on the network. Therefore, the user cannot easily know to which printer the portion of the job was output. In addition, the paper on which printing is carried out using multiple printers must be collated, which is labor-intensive and inefficient.

### SUMMARY OF THE INVENTION

An object of the present invention is to resolve the problem identified above.

Another object of the present invention is to perform control such that a print job including a multiple paper size requirement may be handled by a single printer.

Another object of the present invention is to eliminate the termination of a print job even if the print job includes a multiple paper size requirement.

Another object of the present invention is to perform control such that printing may be carried out for a job that includes a multiple paper size requirement without division of the job into multiple portions.

Another object of the present invention is to provide a device that appropriately selects a printer to which a print job including a multiple paper size requirement is output in accordance with the paper sizes.

These and other objects are attained by an image processing apparatus that is connected to a plurality of printers through a network and that transmits a print job including image data to any printers, the image processing apparatus having a memory that stores paper sizes available in each printer connected to the network such that paper size information is associated to each printer, an obtaining unit that obtains multiple image size information regarding a print job, a comparator that compares each image size and the paper sizes available in each printer, a selector that selects a printer to which the print job is sent based on a degree of matching of the comparison results obtained by the comparator, and a transmitter that transmits the print job to the selected printer selected by the selector.

Moreover, the above-mentioned objects are attained by an image data transmission method to send a print job including image data to a printer selected from a plurality of printers connected to a network, the method having a step of obtaining information regarding paper sizes available in each printer, a step of comparing paper sizes required by the print job and the obtained paper sizes available in each printer, a step of selecting a printer based on the results of the comparison, and a step of transmitting the print job to the selected printer.

The invention itself, together with further objects and attendant advantages, will best be understood by reference to the following detailed description taken in conjunction with the accompanying drawings.

### BRIEF DESCRIPTION OF THE DRAWINGS

FIG. 1 is a drawing showing the entire construction of a system in which image processing apparatuses and printers are connected over a network;

FIG. 2 is a drawing showing the contents of job data sent from the image processing apparatus;

FIGS. 3(A) and 3(B) are drawings showing information regarding paper sizes available in printers;

FIG. 4 is a flow chart showing the sequence of the operation by which the image processing apparatus selects a printer in accordance with the size information in the job data;

FIG. 5 is a drawing showing a size code table stored in the image processing apparatus;

FIG. 6 is a drawing showing the size code table and size information stored in the image processing apparatus;

FIG. 7 is a drawing to explain the method by which the paper size information is incorporated by the image processing apparatus; and

FIG. 8 is a drawing showing the state of storage in the memory of the image processing apparatus.

In the following description, like parts are designated by like reference numbers throughout the several drawings.

### DESCRIPTION OF THE PREFERRED EMBODIMENT

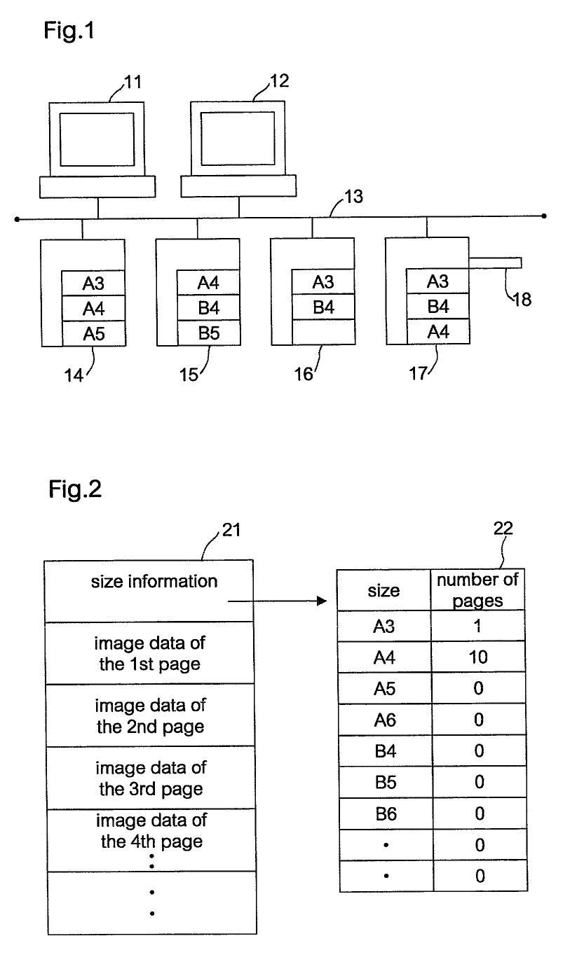

FIG. 1 shows the entire construction of an image processing system in which multiple personal computers (hereinafter ‘PCs’) and multiple printers are connected over a communication cable. In this system, the printers 14, 15, 16 and 17 are connected to the PCs 11 and 12 via the communication cable 13 in a bus connection fashion. Image data is sent from the PCs 11 and 12 to the printers 14, 15, 16 and 17, which print out images. It is also acceptable if transmission of image data is carried out not by PCs but by digital copying machines, scanners or printers that have an image processing capability.

When a print command is given from the PC 11 or 12, one of the printers 14 through 17 performs printing.

Each printer 14 through 17 has paper cassettes of various sizes (A3, A4, A6, B4, B5, etc.) as necessary. The printer 17 also has a manual paper supply unit 18. This paper supply unit 18 may be replaced with a universal cassette, multiple-use manual paper supply inlet, or multi-purpose cassette, for example.

The PCs 11 and 12 are capable of (i) storing the paper sizes available in each printer 14 through 17, which are connected over a network, such that the available paper sizes are associated with each printer, (ii) obtaining multiple image size information regarding the original and original image information, (iii) comparing each image size and the paper sizes available in each printer, (iv) selecting the printer to which the image data should be sent in accordance with the degree of matching of the comparison results, and (v) sending the image data to the selected printer.

The PC or printer has a feature in which the user is notified through display of the proper paper size to be used when a printer equipped with a universal cassette, multiple-use manual paper supply inlet or multi-purpose cassette is selected based on the job data. Consequently, when a printer having a universal cassette or the like is selected and the job is sent to this printer, even if the printer stops operation due to a mismatch between the image size and the available paper sizes, the user can easily and immediately learn the proper paper size to be inserted and act accordingly.

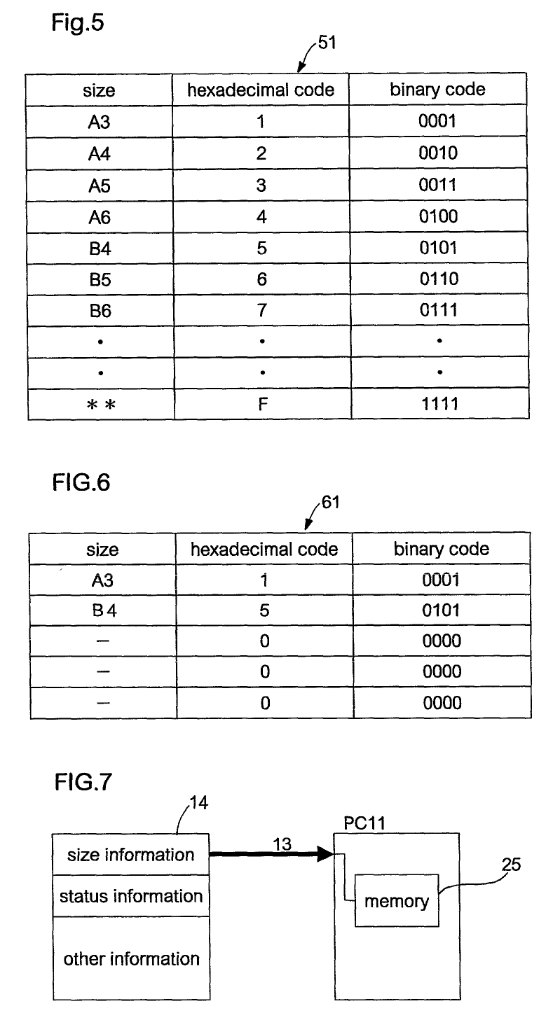

FIG. 2 shows the contents of the job data sent from the PC 11 or 12. At the top of the job data (21) is stored the size information regarding the job data. In the drawing, an example is shown in which the number of pages for each size is stored as the size information (22). It is also possible to store only the information regarding sizes used in the job data, without storing the number of pages for each size. In this case, each size is defined in advance in the form of a code, such that codes are stored as the size information. FIGS. 5 and 6 show a size code table (51) and size information (61), respectively. FIG. 6 shows the case of job data that includes only A3 size and B4 size paper.

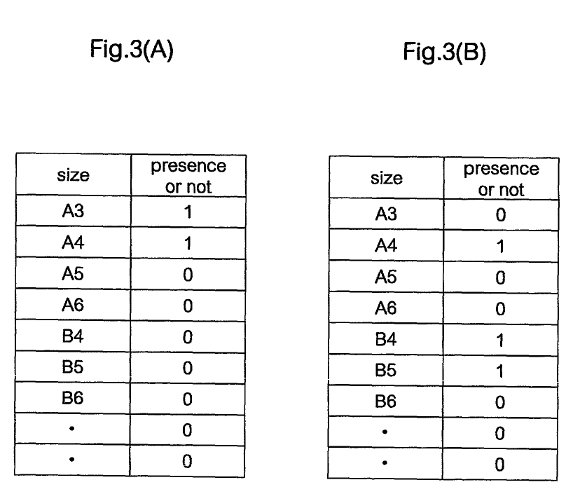

FIGS. 3(A) and 3(B) show information regarding the paper sizes available in the printers 14 and 15 connected over a network, respectively. For each paper size, if paper of that size is available, ‘1’ is stored in memory, and if not, ‘0’ is stored in memory. In this storage method, however, because ‘1’ or ‘0’ must be stored for each paper size, the memory space is consumed. Therefore, a different method is possible in which the available sizes themselves are stored, and this method is shown in FIGS. 5 and 6 as described above.

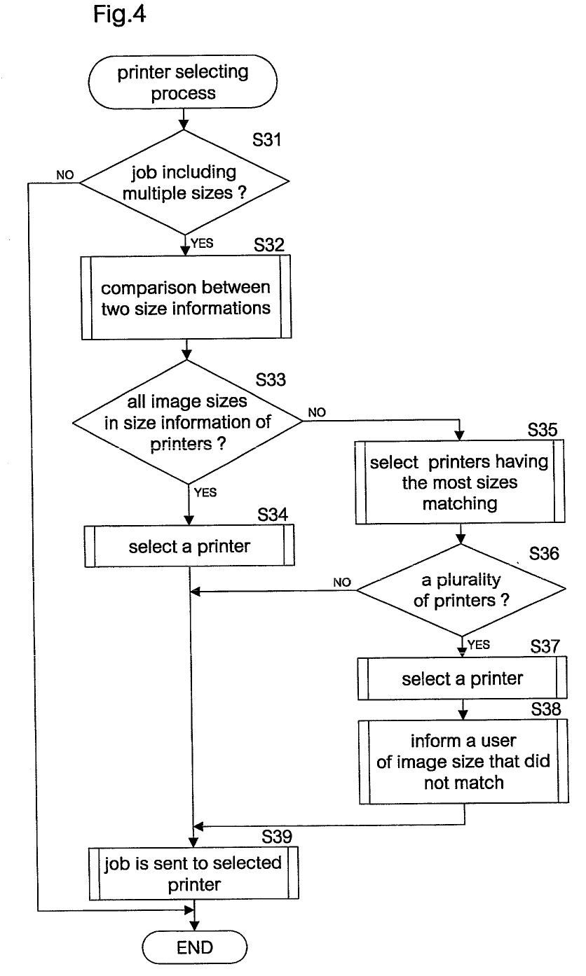

FIG. 4 shows the sequence of the operation of the PC to select a printer in accordance with the size information in the job data. This operation should take place when job data is sent by the PC that functions as a server on the network. In step S31, it is determined from the size information details (22 of FIG. 2) regarding all images, which are located at the top of the job data, whether or not the job data sent from the PC 11 or 12 includes a multiple image size requirement. Where the job data indicates that various sizes coexist, the PC advances to step S32, where it compares all of the image size information in the job data and the information regarding paper sizes available in the printers on the network. In step S33, it is determined whether or not all of the image size information in the job data matches the sizes available in the printers, and in step S34, a printer is selected that holds the paper of the sizes that correspond to the image size information for the entire job.

Where the image size information for the entire job does not match the sizes available in the printers in step S33, a printer that has the most paper sizes that match the image sizes in the job data is selected in step S35. Subsequently, in step S36, it is determined whether or not multiple printers were selected in step S35 above, and if the determination is NO, the PC advances to step S39, but if the determination is YES, a printer that has a universal cassette or manual paper supply tray is selected in step S37. In step S38, the user is notified of all of the image sizes or the image size or sizes that did not match any of the paper sizes available in the selected printer. Consequently, the user can determine the paper size or sizes that should be inserted in the printer, and can easily perform a paper supply operation. In step S39, the job data is sent to the selected printer. In order to store in the memory of the PC the paper sizes available in each printer on the network, data is communicated between the devices in advance such that the paper size information is incorporated in the PC.

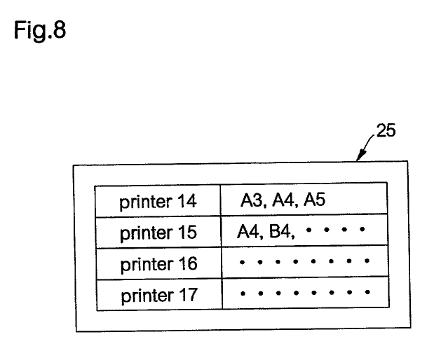

A specific example of the incorporation of the paper size information will now be explained. As shown in FIG. 7, when the PC 11 and printer 14 are turned ON, for example, the printer 14 transmits to the PC 11 signals that indicate that the paper sizes available in the printer 14 are A3, A4 and A5 via the communication cable 13. The paper size information sent from each printer 14 through 17 is organized in a matrix fashion and stored in the memory 25 of the PC 11, as shown in FIG. 8.

Because in this embodiment the most appropriate printer is selected and the job is sent to that printer through the above procedure when the job includes a multiple paper size requirement, one job is no longer divided and output to multiple different printers. In addition, even if the image sizes required by the job and the available paper sizes of the printer do not match completely, the user is notified of the missing paper size or sizes, enabling the user to easily and promptly deal with the situation by inserting the appropriate paper into the printer.

As described above, using this embodiment, when a job in which multiple paper sizes coexist is output, the most appropriate printer is selected, and the job is output to that printer. Consequently, a job is no longer divided and output to multiple different printers. As a result, the user need only retrieve printer paper from a single printer. Furthermore, print jobs are no longer stopped midway through, which prevents inconvenience to other users and helps improve output efficiency.

In addition, even if none of the printers has all of the paper sizes required by the job, when there is a printer that has a paper supply means such as a universal cassette, the paper size to be used may be changed easily if that printer is selected, so that the job may be continued. Further, where the user is notified of the paper size or sizes to be inserted in the paper supply means, the user can promptly deal with the situation. Such prompt handling also becomes possible if the user is notified of all of the required image sizes.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image processing apparatus that is connected to a plurality of printers through a network and that transmits a print job including image data to any printers, the image processing apparatus comprising:
a memory that stores paper sizes available in each printer connected to the network such that paper size information is associated to each printer;
an obtaining unit that obtains multiple image size information regarding a print job;
a comparator that compares each image size and the paper sizes available in each printer;
a selector that selects a printer to which the print job is sent based on a degree of matching of the comparison results obtained by the comparator; and
a transmitter that transmits the print job to the selected printer selected by the selector.

2. An image processing apparatus as claimed in claim 1, wherein the selector selects a printer that has all of the paper sizes that match the image sizes.

3. An image processing apparatus as claimed in claim 1, wherein the selector selects a printer that has the most paper sizes that match the image sizes.

4. An image processing apparatus as claimed in claim 1, wherein where none of the printers has all of the paper sizes that match the image sizes, the selector selects a printer that has a paper supply device through which paper of any size is inserted in the printer.

5. An image processing apparatus as claimed in claim 4, further comprising:
notification means that notifies an user of that size of paper that is inserted in the paper supply device when the paper supply device is selected.

6. An image processing apparatus as claimed in claim 4, wherein said device has notification means that notifies the user of all of the image sizes.

7. An image processing apparatus as claimed in claim 1, wherein data is communicated between the printers in order to store in the memory the information regarding the paper sizes available in each printer.

8. An image data transmission method to send a print job including image data to a printer selected from a plurality of printers connected to a network, comprising the steps of:
obtaining information regarding paper sizes available in each printer;
comparing paper sizes required by the print job and the obtained paper sizes available in each printer;
selecting a printer based on the results of the comparison; and
transmitting the print job to the selected printer.

9. An image data transmission method as claimed in claim 8, wherein the selected printer has the most paper sizes that match the image sizes.

10. An image data transmission apparatus that sends a print job including image data to a printer selected from a plurality of printers connected to a network, the apparatus comprising:
an obtaining unit that obtains information regarding paper sizes available in each printer;
a comparing unit that compares the paper size requested by the print job and the paper sizes available in each printer;
a selecting unit that selects a printer based on the results of the comparison; and
a transmitting unit that transmits the print job to the selected printer.

11. An image data transmission apparatus as claimed in claim 10, wherein the selecting unit selects the printer that has the most paper sizes that match the image sizes.
